(19) United States
(12) Patent Application Publication
(10) Pub. No.: US 2019/0035173 A1
(43) Pub. Date: Jan. 31, 2019

(54) Vehicle Mileage Verification System and Method

(71) Applicants: Julian Harvey, Bridgend (GB); Emanuel Melman, Coral Springs (UD)

(72) Inventors: Julian Harvey, Bridgend (GB); Emanuel Melman, Coral Springs (UD)

(21) Appl. No.: 16/091,993

(22) PCT Filed: Apr. 10, 2017
(86) PCT No.: PCT/GB2017/051000

§ 371 Date: Oct. 7, 2018

(30) Foreign Application Priority Data
Apr. 8, 2016 (GB) 1606176.4

(51) Int. Cl. G07C 5/08; G07C 5/00; G01C 22/00

(52) U.S. Cl. CPC G07C 5/085; G01C 22/00; G07C 5/008

(57) ABSTRACT

A mileage verification system (10) for a vehicle (100) having an odometer (14), the mileage verification system (10) comprising primary and secondary units (12a, 12b) in the vehicle (100) for monitoring mileage travelled by the vehicle (100), the primary unit (12a) being interfaced with the odometer (14) for gathering one set of vehicle mileage data, and the secondary unit (12b) being adapted for gathering another set of vehicle mileage data, independent of the odometer (14); verification means in communication with both units (12a, 12b) for comparing the sets of vehicle mileage data gathered and determining inconsistencies; data storage means (20) in communication with both units (12a, 12b) for storing the vehicle mileage data gathered; communication means (12c) for enabling communication i) between the primary unit (12a) and the verification and data storage means (26, 20), and ii) between the secondary unit (12b) and the verification and data storage means (26, 20); an authentication system for authenticating the identity of the vehicle (100); in use, the authentication system acquiring a Vehicle Identification Number (VIN) from an electronic databus of the vehicle (100), and using the VIN as a tag for each set of vehicle mileage data to associate that data with the vehicle (100), and one or more alerts being issued by the mileage verification system (10) at least if the verification means compares the vehicle mileage data from the primary and secondary units (12a, 12b) and determines them to be inconsistent with one another.

The present invention relates to a system and method for verifying the mileage travelled or covered by a vehicle.

### BACKGROUND TO THE INVENTION

Odometers are provided in cars and other vehicles for measuring the distance travelled by the vehicle since construction. A vehicle which has covered more miles is more likely to suffer a component failure and require repair, increasing maintenance costs and thus decreasing its potential value. Therefore, the odometer reading is often considered to be an important indicator of a vehicle's potential value.

Due to the importance of the odometer reading, some people tamper with the odometer to artificially reduce the mileage to obtain a better re-sale value. Odometer fraud is known as ‘clocking’ in the UK, or ‘busting miles’ in the USA, and has a markedly detrimental impact on the second-hand car sales market. It is generally illegal to tamper with a vehicle odometer to change the apparent distance driven by the vehicle.

When a vehicle undergoes an annual check for roadworthiness (known as an MOT in the UK), mileage is recorded in the testing authority's database, providing a permanent mileage record. However, no verified record of the vehicle mileage is available before this time, because an MOT certificate is not required during the first three years following vehicle registration. These three years can be a relatively high mileage period for a vehicle (especially leased vehicles), causing the re-sale value to drop significantly.

Furthermore, for leased vehicles in particular, if the allowed mileage is exceeded then charges are levied. Consequently, there is an incentive for the drivers of leased vehicles to obtain the black market services with the intention of tampering with the odometer for a fee, rather than pay an excess mileage charge imposed by the leasing company by exceeding the agreed miles in the contract. Therefore, in addition to the second-hand vehicle market, another black market has developed for odometer fraud in leased vehicles to avoid these charges.

It is also known that some vehicles have had their mileages fraudulently moved forward for financial gain. For example, this can occur in cases where a driver is paid an amount per mile travelled and wants to over-claim for the journeys.

It is an object of the present invention to reduce or substantially obviate the aforementioned problems.

### STATEMENT OF INVENTION

According to a first aspect of the present invention, there is provided a mileage verification system for a vehicle having an odometer, the mileage verification system comprising
primary and secondary units in the vehicle for monitoring mileage travelled by the vehicle, the primary unit being interfaced with the odometer for gathering one set of vehicle mileage data, and the secondary unit being adapted for gathering another set of vehicle mileage data, independent of the odometer;
verification means in communication with both units for comparing the sets of vehicle mileage data gathered and determining inconsistencies;
data storage means remote from the vehicle and in communication with both units for storing the vehicle mileage data gathered;
communication means for enabling communication
i) between the primary unit and the verification and data storage means, and
ii) between the secondary unit and the verification and data storage means; and
an authentication system for authenticating the identity of the vehicle;
   in use, the authentication system acquiring a Vehicle Identification Number (VIN) from an electronic databus of the vehicle, and using the VIN as a tag for each set of vehicle mileage data to associate that data with the vehicle,
one or more alerts being issued by the mileage verification system at least if the verification means compares the vehicle mileage data sets from the primary and secondary units and determines them to be inconsistent with one another.

Advantageously, by recording vehicle mileage via two independent methods, inconsistencies can be identified. If the mileage data set based on a vehicle odometer does not match the mileage data set gathered independently of the odometer, it will be apparent to potential buyers for that vehicle that the odometer reading is fraudulent by using this system. As such, vehicles having verifiable mileage histories will become more highly valued, in a similar manner to a vehicle having a full service history, since buyers will have verified information at hand.

The data may be inconsistent if the data gathered or recorded by each unit is sufficiently different to exceed known tolerances. Ideally the data from each will be nearly identical, but if significant differences are present then the data sets are determined to be inconsistent.

A threshold for inconsistency may be set at, for example, a 1% variance in total mileage determined from each data set. This may be an acceptable limit for a vehicle having travelled 30000 miles prior to resale, equivalent to a 300 mile discrepancy, which will not impact the resale value significantly. That said, in practice the difference should be negligible if odometer fraud has not occurred.

Regular back-ups of the data can be performed on data in the data storage means to keep lasting records of vehicle mileage. Consequently, the black market for clocking vehicles will be very difficult to accomplish, since the time and effort required to tamper with the on-board mileage of a vehicle, the data for that vehicle in the data storage means, as well as all of the back-ups of the corresponding mileage data, will mean it is no longer worthwhile. Having confirmation of vehicle mileage will also give consumers greater confidence in the provenance of a second-hand vehicle when buying.

An authentication system is provided for authenticating the identity of the vehicle. The authentication system may establish the identity of the vehicle before the vehicle mileage data is stored in the data storage means. Preferably, the mileage verification system issues one or more alerts if the authentication system cannot authenticate the identity of the vehicle, or if it identifies that the identity of the vehicle has changed.

The Vehicle Identification Number (VIN) is used to authenticate the vehicle. The VIN is recorded electronically in modern vehicles. The VIN may be acquired by the primary unit, which may be interfaced with electronic systems (e.g. an electronic databus) in the vehicle. The VIN may be sent to a remote database or records system during or as part of the authentication process. The VIN is used as a specific tag for mileage data to associate it with a specific vehicle. The VIN can be tagged to the mileage data from either or both of the primary and secondary units. For example, the VIN may be tagged systematically or randomly to a subset of the mileage data points in a given bundle of mileage data, or to every data point. The system may apply cryptographic functions to the VIN within the data, for example to prevent or detect later alteration of the VIN after it has been stored in the data storage means.

Using the VIN for authentication ties the recorded mileage to the vehicle the system is installed in. In other words, the mileage data is tagged with the VIN so that the origin of the data can be proven. Preferably, this occurs before the data is transmitted from the vehicle. If the authenticity of the mileage reading for a vehicle were to be called into question, reviewing vehicle mileage data linked to the VIN of that vehicle would enable confirmation of whether the mileage reading had been tampered with.

Authenticating the VIN with an authorised records system can confirm that the vehicle has the expected characteristics as an assurance that mileage is not being fraudulently recorded using a different vehicle. The DVLA in the UK, for example, maintains a database of relevant VINs. This could be used to authenticate the VIN by checking it against data recorded for the vehicle such as make, model, registration number and/or colour, for example.

In practice, the VIN may simply be tagged to each set of data and later authenticated when stored in the data storage means. Authentication may not be required for most vehicles, but would be possible for any vehicle having the mileage verification system whose mileage history (i.e. odometer reading) was in doubt.

The secondary unit may be a locating device for monitoring the position and movement of the vehicle. This may be done using a global positioning system (GPS) receiver. Alternatively, this may be done using any other location determining technology or means.

If using GPS or another location determining means, this enables monitoring of the vehicle in most locations. GPS is a reliable system for monitoring vehicle travel independently of the on-board odometer, and is generally accurate to within 10 metres or so, although higher accuracy may be possible. Since vehicle mileage normally runs to thousands of miles in the first few years, and vehicle journeys typically last for miles, GPS resolution on the order of metres will average to fairly negligible measurement error. If available, a pre-existing satellite navigation system which is built into or otherwise connected to the vehicle as a standalone device can be used as the locating device. The locating device of the system may allow satellite navigation as an auxiliary function. A receiver may be provided which uses a different location-finding system such as GLONASS or cell towers, for example. Multiple receivers may be provided to support multiple location-finding systems.

One or more alerts may be issued by the mileage verification system if the primary and/or secondary unit provides an incomplete set of vehicle mileage data. The system may be adapted to identify and/or record vehicle location for each point in a vehicle journey. The system may be adapted to do so where the mileage data set is incomplete and/or determined to be inconsistent.

Sometimes, the primary or secondary units may not record data for a portion of a vehicle's journey. For example, if a vehicle breaks down and a recovery vehicle transports it to a new location, or if the vehicle is on a ferry, the primary unit would not register a significant change in the odometer reading, but the secondary unit would gather data indicating movement of the vehicle. This can result in conflicting data sets, which should be flagged for review.

In either case, issuing an alert flags the data for review, in order to verify the actual mileage driven by the vehicle under its own power, to maintain accurate records for that vehicle. The inconsistencies may be self-explanatory, and dismissed automatically or on review. If the mileage data is flagged as inconsistent, further data related to the position of the vehicle at the time of the inconsistency can be stored for review, for example, if not all position data.

A third party verification service may be provided, allowing for a certificate of mileage authenticity. If many alerts remain against a particular vehicle's record, this may decrease consumer confidence in the recorded mileage history. If needed, a third party review of the inconsistencies against the position data, for example, could reconcile or authorise any inconsistencies, which would bolster the potential value of the verified mileage certificate. Hence, recording the position data is particularly useful to explain inconsistencies that arise innocently, avoiding a detrimental impact on the value or accuracy of any mileage verification certificate.

The gathered vehicle mileage data may be scheduled for communication to and storage in the data storage means at a predetermined interval. The data can be communicated to the data storage means with a frequency of at least once a month, for example. The frequency could be any, being weekly or daily, for example. The interval between communications, or frequency of communicating the data, may be regular or irregular. Preferably, one or more alerts may be issued by the mileage verification system if the predetermined interval elapses without the vehicle mileage data being communicated to and stored in the data storage means.

Regularly storing the data online allows for the mileage to be verified at regular intervals. It also eliminates the possibility of tampering. The interval between data transfers can be customised to accommodate factors such as how often the vehicle is used, for example. If there is no communication of newly acquired vehicle mileage data for a long period of time (i.e. not data which is already in the data storage means), the system flags this for review, in case the system has been disabled, for example.

The communication means may be adapted to enable SMS communication between the primary unit and the data storage means. The communication means may be adapted to enable USSD and/or GPRS communication between the primary unit and the data storage means. Any practical wide area communications means could be utilised to transfer information to and from the system.

This allows remote wireless transfer of the vehicle mileage data for storage. This is also particularly useful if the vehicle is in a remote location and mileage data needs be communicated, because telephone communication towers are positioned to enable relatively complete coverage in the UK and many other countries. This permits regular data updates to be delivered to the data storage means.

A local data storage device, additional to the remote data storage means, may be provided in the vehicle and connected to the primary and secondary units, for storing the vehicle mileage data until communicated to the data storage means. The local data storage device may have sufficient memory to store vehicle mileage data gathered over at least the predetermined interval. Ideally, the local data storage device has more memory than this in case the device is out of signal range and cannot upload data as scheduled.

This allows data to be gathered and held locally to support less frequent transfer to the data storage means, without overwriting pre-existing data.

The data storage means may include a cloud storage system. In other words, the data storage means may include an internet-based data storage system, which enables access from anywhere with an internet connection.

Either or both of the primary and secondary units may be integrated into the vehicle. A single device may be provided for the vehicle and may include the primary unit and the secondary unit. The primary and secondary units may be provided as a single electronic unit capable of functioning as both.

Preferably, the communication means is included in the single device. More preferably, if provided, the local data storage device is included in the single device. The single device may be integrated into the vehicle. The verification means may be included in the single device. The verification means may alternatively be provided remotely from the vehicle. For example, verification could be undertaken at the remote data storage means, for example.

Integrating the units into the vehicle makes them less obtrusive and potentially more difficult to access and tamper with. A single device makes installing of the system in older vehicles a relatively simple procedure. This may be adopted by a motor manufacturer for new vehicles on the production line. Remote verification is preferred to simplify the device provided to the end user, and enable centralised updates of rules or criteria governing data verification and inconsistencies.

The primary and/or secondary units, at least, may be powered by the vehicle. One or more alerts may be issued by the mileage verification system if power to at least one of the units is disconnected or becomes depleted. Either or both units may be connected to an auxiliary power source for enabling this. For example, batteries may be provided.

Being mainly powered from the vehicle ensures that the system is powered when the vehicle is running, and hence when the vehicle is being driven, so that mileage is always recorded. If main power is lost, then the backup batteries allow the system to record an alert as an indication that the mileage should be carefully verified, in case the primary and secondary units have been tampered with.

A remote access system may be provided for accessing the data storage means and reviewing the one or more alerts generated by the mileage verification system. The alert(s) may be provided as electronic notification(s) accessible via at least the remote access system.

A web-based portal, for example, can be provided and accessed by authorised operators for checking the vehicle mileage data on a given vehicle. This can be used to manually check vehicle mileage. This may be done in addition to any automated mileage checks undertaken by the system. Where alerts are provided, the operator has the option to review the alerts and escalate for detailed review if necessary.

According to a second aspect of the present invention, there may be provided a vehicle comprising the mileage verification system of the first aspect of the invention. The vehicle may have been retrofitted to include the mileage verification system.

The vehicle according to the second aspect of the invention may include one or more features presented in relation to the system of the first aspect of the invention.

According to a third aspect of the present invention, there is provided a method of verifying mileage travelled by a vehicle, the method comprising the steps of:
a) using a primary unit in the vehicle to gather vehicle mileage data measured via an odometer in the vehicle;
b) using a secondary unit in the vehicle to gather vehicle mileage data measured independently of the odometer;
c) acquiring a Vehicle Identification Number (VIN) from an electronic databus of the vehicle;
d) tagging the vehicle mileage data of steps (a) and (b) with the VIN to associate that data with the vehicle;
e) storing the vehicle mileage data in a data storage means remote from the vehicle;
f) verifying the vehicle mileage data by comparing the vehicle mileage data gathered from the primary and secondary units to each other, and determining whether there are any inconsistencies; and
g) issuing one or more alerts if the respective mileage data from the odometer and independent means are determined to be inconsistent with one another.

The advantages of the method are similar to those discussed for the system of the first aspect of the invention. Note that steps (a) and (b) can be done in either order, or concurrently.

The vehicle mileage data in step (b) may be gathered by using a global positioning system (GPS) to monitor the vehicle.

The vehicle mileage data may be communicated to the data storage means by wireless transmission.

The method may include the step of accessing and reviewing the one or more alerts using a remote access system connected to the data storage means.

This allows discrepancies in the data collected via steps (a) and (b) to be reviewed by a person to determine whether the recorded vehicle mileage is genuine. The inconsistencies can be correlated with any other events in the journey, such as a loss of GPS signal (if used), to decide whether the inconsistencies in the mileage data can be explained, or whether they may arise due to odometer fraud.

The method may be performed using a vehicle mileage verification system according to the first aspect of the invention. The method of verifying vehicle mileage according to the third aspect of the invention may include one or more features presented in relation to the system of the first aspect of the invention. The method may also be performed for or using a vehicle according to the second aspect of the invention.

### BRIEF DESCRIPTION OF THE DRAWINGS

For a better understanding of the present invention, and to show more clearly how it may be carried into effect, reference will now be made by way of example only to the accompanying drawings, in which:

FIG. 1 is a schematic diagram of the main components of a vehicle mileage verification system according to the present invention; and

FIG. 2 is another schematic diagram of the system in FIG. 1.

### DESCRIPTION OF PREFERRED EMBODIMENTS

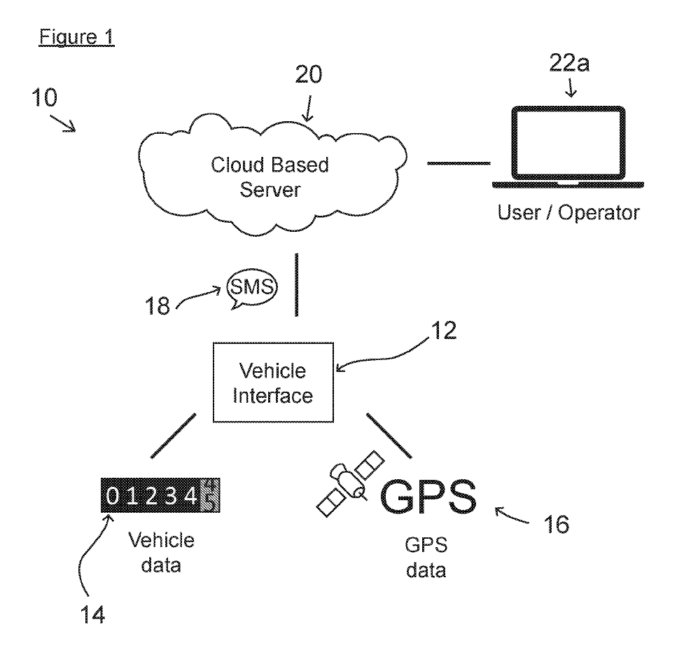

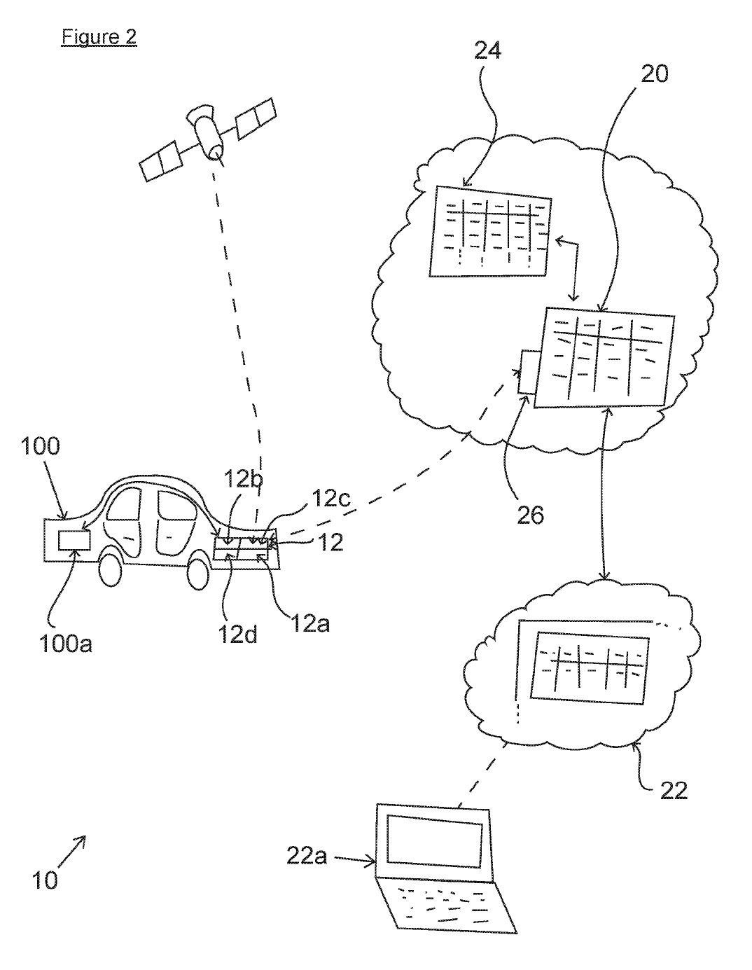

Referring to FIGS. 1 and 2, the main components of a mileage verification system are indicated generally at 10. In this embodiment, the system 10 is integrated into a vehicle 100 having an odometer 14. The system 10 includes a vehicle interface device 12 in and powered by the vehicle 100. The system 10 also includes a global positioning system (GPS) 16 and a remote server 20. It will be appreciated that the system 10 can be installed or retrofitted to a vehicle in other embodiments. Having the device 12 ‘in’ the vehicle means that the device is physically connected to the vehicle 100, so that the device 12 moves with the vehicle 100 during travel.

The vehicle interface device 12 includes a mileage counter 12a and a GPS receiver 12b. The mileage counter 12a is connected to the odometer 14 to allow the counter 12a to read the vehicle mileage recorded by the odometer 14. In other words, the counter 12a is interfaced with the odometer 14. The GPS receiver 12b communicates with the GPS 16 in a conventional manner. The GPS receiver 12b does not communicate with the odometer 14. In other words, the mileage readings obtained via the GPS-related components are independent from the odometer mileage readings.

The vehicle interface device 12 further includes wireless communication means 12c for sending and receiving wireless signals. The communication means 12c includes a transmitter and a receiver. The communication means 12c is linked to the GPS receiver 12b and mileage counter 12a. This enables vehicle mileage data collected via both the odometer 14 and the GPS 16 to be transmitted from the transmitter. The transmitter is able to send information via SMS 18 to the server 20. This enables data transmission whilst driving. The receiver can receive a confirmation message by return of successful receipt of the transmission. In some embodiments, the transmitter and receiver may be adapted to communicate via wifi, GSM (mobile networks) and/or other wireless transmissions.

The vehicle 100 has an electronic system 100a for controlling aspects of the vehicle 100. The vehicle interface device 12 is connected to the vehicle's electronic system 100a. This enables the device 12 to access vehicle-specific information such as the Vehicle Identification Number (VIN) and recorded characteristics of the vehicle 100. Other vehicle-specific information could be used as a vehicle identifier.

The server 20 securely stores vehicle mileage data. The server 20 is cloud-based and accessible via the internet. The server 20 is firewalled for security reasons, and undergoes regular backups. The server 20 communicates with the vehicle interface device 12 via the internet and the communication means 12c. This allows vehicle mileage data gathered by the device 12 to be transmitted to and stored in the server 20.

The device 12 in this embodiment is programmed to send vehicle mileage data to the server 20 at predetermined time intervals, i.e. on a regular schedule. The data is tagged with the VIN. The data includes vehicle mileage and location data. The interval in this case can be set to be daily. It will be appreciated that other time intervals may be used. In other embodiments, predetermined mileage intervals may be used (instead of or in addition to time intervals) to trigger the transfer of mileage data. For example, data may be uploaded every 50 miles travelled by the vehicle 100.

In this embodiment, the device 12 includes a local data storage module 12d for temporarily storing vehicle mileage data from the counter 12a and the GPS receiver 12b between intervals. The capacity of the module 12d should be selected to accommodate all data gathered over at least the predetermined interval. Both the counter 12a and GPS receiver 12b periodically store information in the storage module 12d to build up mileage data acquired at common times. In other words, the time stamps (or time of recordal) on data acquired from the odometer 14 and the GPS 16 should be the same, to support cross-comparison of the mileage data. A data threshold may be set to trigger data upload if the local data storage module 12d has nearly reached its data capacity, to avoid data loss.

The components 12a, 12b, 12c, 12d of the vehicle interface device 12 are all electronically interconnected in this embodiment, to facilitate communication between the components.

The system 10 includes a remote access system 22. The remote access system 22 in this embodiment is a web-based portal (accessible via the internet), which enables third party access to the server 20 and data stored on the server 20 from a remote location, using a laptop 22a, for example. The mileage verification system 10 is maintained by a regulated third party, so the vehicle user cannot alter the mileage history records themselves via the remote access system 22.

The system 10 includes a vehicle information database 24. The database 24 in this embodiment is accessible via the internet. The server 20 can communicate with the database 24 for authenticating the identity of the vehicle 100. The server 20 uses the VIN of the vehicle 100 to query the database 24. The database 24 then returns confirmation or otherwise regarding whether the VIN matches the characteristics of the vehicle 100. This provides an authentication system for ensuring that the system 10 has not been connected to a different vehicle than that it is intended to monitor, and so vehicle mileage data will not be collected for one vehicle and stored for another. In practice, a mileage verification certificate may be contingent on the VIN matching the expected vehicle characteristics, and may have a corresponding caveat to this effect.

In this embodiment, a verification program 26 is provided in the server 20. The program 26 can communicate with the vehicle interface device 12 and server 20. The program 26 automatically compares the sets of vehicle mileage data sent to the database 24 to verify consistency. One or more verification rules may be used, to determine whether any variations constitute an inconsistency. The data may also be compared with the last recorded set of data for that vehicle. Different rules may be used depending on the age or expected usage of a vehicle. For example, lease vehicles may have different rules to vehicles sold outright.

Where data is found to be inconsistent, location data is stored for the relevant data points. Otherwise, location data is not stored, for maintaining user privacy.

If the data is found to be inconsistent, such as differing by more than a certain percentage, the data is still stored but is flagged as suspect. Vehicles with higher amounts of suspect data will have an inherently higher uncertainty in total mileage covered, which may impact subsequent resale value. It will be appreciated that a verification check may be performed in the device 12, in addition to of instead of a verification check at the database end. For example, the verification program could be provided in the data storage module 12d. Human verification of certain anomalies/inconsistencies may be employed. A report can then be generated giving a ‘confidence score’ of the accuracy of the mileage recorded.

There are various scenarios in which the system 10 generates alerts to flag that there are inconsistencies or faults with the data recorded or the system 10 itself. In this embodiment, alerts generated by the verification program 26 or database 24 as appropriate. Alerts are logged against the data where the data is deemed to be inconsistent. In one embodiment, the alerts can be reviewed using the remote access system 22. An authorised or regulated third party may un-flag the data if appropriate, i.e. on reviewing position data for the vehicle and establishing that the inconsistency does not arise from odometer fraud, to ensure the data in the server 20 remains accurate and the mileage verification system 10 can be relied upon.

If the vehicle mileage data gathered by the odometer 14 does not match the data gathered via GPS 16, an alert is raised. The severity of the alert is tailored to the degree of mismatch. If the difference is less than 0.1%, for example, the severity is minimal. If the difference exceeds 2.5%, for example, a severe warning is raised. The thresholds set take account of the GPS resolution and any systematic or other errors in the system 10.

Alternative threshold values may be used; for example, differences based on absolute mileage values may be used. In such an embodiment, a difference of greater than 100 miles might give rise to a severe alert. Separate thresholds may be applied to the total vehicle mileage history and to the mileage data gathered, for example, on a per journey or per time interval basis.

The following situations are examples of when alerts may be raised:
the vehicle identity cannot be authenticated via the database 22, e.g. the database 22 is unavailable or cannot find the VIN;
the vehicle identity is found to be different to the expected vehicle identity, or the previously recorded VIN at the time, e.g. indicating the device 12 has been installed in a different vehicle;
the vehicle mileage data from either or both the counter 12a and GPS receiver 12b is incomplete, e.g. corrupted during transmission/collection, or results in a non-contiguous line when plotted over time, e.g. loss of GPS signal, indicating instantaneous travel over large distances from one time stamp to another;
the vehicle mileage data from either the counter 12a or GPS receiver 12b is unchanged whilst the other records mileage, or if a mileage decrease occurs;
there is no communication between the device 12 and the server 20 for a period of time, e.g. a period exceeding the interval set for storing data in the server 20;
the odometer 14 is changed or removed from the vehicle;
the device 12 is disconnected from its power source (either the vehicle, or its own battery back-up).

In use, the device 12 finds the location of the vehicle 100 via the GPS receiver 12b, and begins recording odometer readings and GPS data in the data module 12d, along with time stamps for both.

An identity check can be carried out each time the device 12 communicates, i.e. for each instance of use where data is being captured. The identity check can be carried out at a later time instead, via the server 20, once the server 20 has received the data from the vehicle interface device 12.

Where a check is carried out on device activation, before transmitting data to the server 20, the vehicle interface device 12 requests the VIN by reading software over a specific databus system in the vehicle electronics. Once acquired, the device 12 queries the database 24 by sending the VIN and any other required information via the communication means 12c. If the VIN matches the vehicle 100, the identity of the vehicle 100 is confirmed. The vehicle mileage data from both the counter 12a and GPS 12b is then marked as authentic and transmitted to the server 20, along with the VIN. It will be appreciated that verifying the vehicle identity can be done at any stage of the mileage verification process.

Once transmitted to the server 20 via the communication means 12c, the verification program cross-checks the data to identify variations in the data which fall outside the set tolerance thresholds. Data is stored in date order. Any data which is inconsistent is flagged (i.e. an alert is generated) and can later be reviewed on application by a vehicle owner or prospective buyer, to verify the mileage history record. Data for a specific vehicle in the database is identifiable via its VIN.

Over time, the system 10 builds up a complete record of the vehicle's mileage history, so that future buyers can be confident that the vehicle has not be subject to odometer fraud.

The embodiments described above are provided by way of example only, and various changes and modifications will be apparent to persons skilled in the art without departing from the scope of the present invention as defined by the appended claims.

1. A mileage verification system for a vehicle having an odometer, the mileage verification system comprising
primary and secondary units in the vehicle for monitoring mileage travelled by the vehicle, the primary unit being interfaced with the odometer via an electronic databus of the vehicle for gathering one set of vehicle mileage data, and the secondary unit being adapted for gathering another set of vehicle mileage data, independent of the odometer;
verification means in communication with both units for comparing the sets of vehicle mileage data gathered and determining inconsistencies;
data storage means remote from the vehicle in communication with both units for storing the vehicle mileage data gathered;
communication means for enabling communication
i) between the primary unit and the verification and data storage means, and
ii) between the secondary unit and the verification and data storage means; and
an authentication system for authenticating the identity of the vehicle;
in use, the authentication system acquiring a Vehicle Identification Number (VIN) from an electronic databus of the vehicle, and using the VIN as a tag for each set of vehicle mileage data to associate that data with the vehicle, and
one or more alerts being issued by the mileage verification system at least if the verification means compares the vehicle mileage data from the primary and secondary units and determines them to be inconsistent with one another.

2. The mileage verification system as claimed in claim 1, in which the primary unit acquires the VIN from the electronic databus of the vehicle each time mileage data is gathered.

3. The mileage verification system as claimed in claim 2, in which one or more alerts are issued by the mileage verification system if the authentication system cannot authenticate the identity of the vehicle, or identifies that the identity of the vehicle has changed.

4. The mileage verification system as claimed in claim 1, in which the secondary unit is a GPS receiver for monitoring the position and movement of the vehicle.

5. The mileage verification system as claimed in claim 1, in which one or more alerts are issued by the mileage verification system if the primary and/or secondary unit gathers an incomplete set of vehicle mileage data.

6. The mileage verification system as claimed in claim 1, in which the gathered vehicle mileage data is scheduled for communication to and storage in the data storage means at a predetermined interval of one month or less.

7. The mileage verification system as claimed in claim 6, in which one or more alerts are issued by the mileage verification system if the predetermined interval elapses without the vehicle mileage data being communicated to and stored in the data storage means.

8. The mileage verification system as claimed in claim 1, in which the communication means enables communication between the primary unit and the data storage means in at least one of the following ways: SMS, USSD, GPRS.

9. The mileage verification system as claimed in claim 1, in which a local data storage device is provided in the vehicle and connected to the primary and secondary units, for storing the vehicle mileage data until communicated to the data storage means.

10. The mileage verification system as claimed in claim 1, in which the data storage means includes a cloud storage system.

11. The mileage verification system as claimed in claim 1, in which at least the primary unit and the secondary unit are provided as part of a single device in the vehicle.

12. (canceled)

13. The mileage verification system as claimed in claim 1, in which at least the primary and/or secondary units are powered by the vehicle.

14. The mileage verification system as claimed in claim 13, in which one or more alerts are issued by the mileage verification system if power to at least one of the units is disconnected or becomes depleted.

15. The mileage verification system as claimed in claim 1, in which a remote access system is provided for accessing the data storage means and reviewing the one or more alerts generated by the mileage verification system.

16. The mileage verification system as claimed in claim 15, in which the one or more alerts are provided as electronic notifications accessible via at least the remote access system.

17. (canceled)

18. A method of verifying mileage travelled by a vehicle, comprising the steps of:
a) using a primary unit in the vehicle to gather vehicle mileage data measured via an odometer in the vehicle;
b) using a secondary unit in the vehicle to gather vehicle mileage data measured independently of the odometer;
c) acquiring a Vehicle Identification Number (VIN) from an electronic databus of the vehicle;
d) tagging the vehicle mileage data of steps (a) and (b) with the VIN to associate that data with the vehicle;
e) storing the vehicle mileage data in a data storage means remote from the vehicle;
f) verifying the vehicle mileage data by comparing the vehicle mileage data gathered from the primary and secondary units to each other, and determining whether there are any inconsistencies; and
g) issuing one or more alerts if the respective vehicle mileage data from the odometer and independent means are determined to be inconsistent with one another.

19. The method of verifying mileage travelled by a vehicle as claimed in claim 18, in which the VIN in step (c) is acquired by the primary unit.

20. The method of verifying mileage travelled by a vehicle as claimed in claim 18, in which the vehicle mileage data in step (b) is gathered by using a global positioning system (GPS) for monitoring the vehicle.

21. The method of verifying mileage travelled by a vehicle as claimed in claim 18, further including the step of storing the vehicle mileage data gathered in steps (a) and (b) in data storage means.

22. (canceled)

23. The method of verifying mileage travelled by a vehicle as claimed in claim 21, further including the step of accessing and reviewing the one or more alerts using a remote access system connected to the data storage means.

24. (canceled)
